(19) United States
(12) Patent Application Publication
(10) Pub. No.: US 2019/0034984 A1
(43) Pub. Date: Jan. 31, 2019

(54) THIRD-PARTY AID PAYMENT SYSTEM AND METHOD

(71) Applicant: TAIWAN FINTECH CORPORATION, FUSION$360, TAIPEI CITY (TW)

(72) Inventors: Han Chao LEE, TAIPEI CITY (TW); Ko Yang WANG, TAIPEI CITY (TW); Grace Yuh-Jiun LIN, TAIPEI CITY (TW)

(21) Appl. No.: 16/012,756

(22) Filed: Jun. 19, 2018

(30) Foreign Application Priority Data
Jul. 31, 2017 (TW) 106125731

(51) Int. Cl. G06Q 30/02; G06Q 20/06; G06Q 30/04

(52) U.S. Cl. CPC G06Q 30/0279; G06Q 20/20; G06Q 30/04; G06Q 20/065

(57) ABSTRACT

A third-party aid payment system and method are provided. The payment system stores a beneficiary's identifier and a donation beneficiary record. The donation beneficiary record is related to a donation from a donator to the beneficiary. The donation beneficiary record includes a beneficial digital currency account identifier, a donation disbursement condition, and a beneficial digital currency balance. The payment system receives the beneficial digital currency account identifier, a product identifier, and a bill of a consumption fee. The payment system determines that the product identifier conforms to the donation disbursement condition and that a subsidized fee related to the consumption fee is not greater than the beneficial digital currency balance and then subtracts the subsidized fee from the beneficial digital currency balance.

### PRIORITY

This application claims priority to Taiwan Patent Application No. 106125731 filed on Jul. 31, 2017, which is hereby incorporated by reference in its entirety.

### FIELD

The present invention relates to a third-party aid payment system and method. More particularly, the present invention relates to a third-party aid payment system and method that involve digital currency.

### BACKGROUND

In the modern society, there are a lot of cases where a third-party aids (e.g., donations, subsidizes, coupons, sponsors, awards, presents, or rewards) others in consumption of commodities and/or services. That is, the whole or a part of a bill of a consumption fee of one or more commodities and/or services are paid by a third-party donator for a beneficiary, examples of which include subsidies from the government, donations from public interest groups, awards to employees by enterprises, dividend rewards from banks, or the like. Currently, there are two operation models regarding donating to others in payment of commodity and/or service consumptions: reimbursement or advances. When the first operation model is adopted, the beneficiary requests payment from the donator by submitting a receipt of a consumption after the beneficiary has consumed a commodity and/or service. The drawback of the first operation model is that the beneficiary has to advance the payment, which tends to make the beneficiary cash-strapped. When the second operation model is adopted, the donator provides a cash fund to the beneficiary in advance, which, however, tends to cause waste or misuses of the money due to lack of an real-time auditing mechanism or even frauds.

Accordingly, there is an need for a donation/subsidy payment system and method that will not make the beneficiary cash-strapped and can audit the donation/subsidy funds in real time.

### SUMMARY

The disclosure includes a conditional payment system. The payment system comprises a digital currency recording device and an auditing system electrically connected to the digital currency recording device. The digital currency recording device stores an identifier of a beneficiary and a donation beneficiary record related to a donation from a donator to the beneficiary. The donation beneficiary record comprises a beneficial digital currency account identifier, a donation disbursement condition, and a beneficiary digital currency balance. The auditing system is electrically connected to a sales terminal device and receives the beneficial digital currency account identifier, a product/service identifier (called product identifier below), and a bill of a consumption fee from the sales terminal device. The auditing system determines that the product identifier conforms to the donation disbursement condition and that a subsidized fee related to the consumption fee is not greater than the beneficial digital currency balance, and subtracts the subsidized fee from the beneficial digital currency balance according to the determination result that the product identifier conforms to the donation disbursement condition and that the subsidized fee related to the consumption fee is not greater than the beneficial digital currency balance.

The disclosure also includes a conditional payment method adapted for a serving system. The serving system stores an identifier of a beneficiary and a donation beneficiary record related to a donation from a donator to the beneficiary. The donation beneficiary record comprises a beneficial digital currency account identifier, a donation disbursement condition, and a beneficiary digital currency balance. The payment method comprises the following steps of: (a) receiving the beneficial digital currency account identifier, a product identifier, and a bill of a consumption fee from a sales terminal device, (b) determining that the product identifier conforms to the donation disbursement condition and that a subsidized fee related to the consumption fee is not greater than the beneficial digital currency balance, and (c) subtracting the subsidized fee from the beneficial digital currency balance according to the determination result that the product identifier conforms to the donation disbursement condition and that the subsidized fee related to the consumption fee is not greater than the beneficial digital currency balance.

According to the payment system and method, at least the donation beneficial currency balance donated by the donator to the beneficiary and the corresponding donation disbursement condition are stored. If a consumption of the beneficiary conforms to the donation disbursement condition, the payment system pays the subsidized fee of this consumption of the beneficiary from the donation beneficial currency balance in real time. With the payment system and the payment method according to the present invention, the beneficiary does not have to advance the consumption fee of the consumed commodity and/or service and the donator can audit whether the beneficiary's consumption conforms to the donation disbursement condition to avoid misuse or waste of the subsidy by the beneficiary.

When the payment system and the payment method are used with a sales terminal device, conveniences and timeliness achieved by the payment system will become more prominent. Additionally, the payment system of the present invention can also be responsible for management of digital currency accounts of the payment system, the donator, the beneficiary, and the seller. The donator can conveniently set and suspend the donation, and the seller can request payment from the payment system conveniently. Furthermore, when the payment system and the payment method of the present invention are used with a banking system of a financial institute or a fourth party providing exchange services, exchange between fiat currencies and digital currencies can be done in response to operations from the user (e.g., a donator, a beneficiary, or a seller) so that the payment system can serve the users more conveniently.

In addition, the donor or the merchant can set conditions with the beneficiary so they can allow the beneficiary to withdraw cash or digital currency from the account or temporarily have negative balance in the account based on certain pre-set conditions. These conditions may require the beneficiary put cashes or digital currency into the account once or periodically until certain conditions are met before they can use the conditional payment from the donor again.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A depicts a schematic framework of a payment system 1 according to a first embodiment;

FIG. 1B depicts a specific example of data stored in the digital currency recording device 11;

FIG. 1C depicts another implementation of the payment system 1;

FIG. 2 depicts a schematic framework of a payment system 2 according to a second embodiment;

FIG. 3A depicts a schematic view of a third embodiment;

FIG. 3B depicts a schematic view of other embodiment that provides digital currency exchange services;

FIG. 3C depicts an exemplary architecture for the third kind of exchange;

FIG. 4A depicts a flowchart of a payment method according to a fourth embodiment;

FIG. 4B depicts a flowchart of a donation setting process that can be executed by the payment method;

FIG. 4C depicts a flowchart of a first kind of exchange between a fiat currency and a digital currency;

FIG. 4D depicts a flowchart of a second kind of exchange between a fiat currency and a digital currency;

FIG. 4E depicts a flowchart of a second kind of exchange between different types of digital currencies in some other embodiments;

FIG. 4F depicts a flowchart of a third kind of exchange between a fiat currency and a digital currency; and

FIG. 4G depicts the additional steps that can be executed for the third kind of exchange.

### DETAILED DESCRIPTION

In the following description, the payment system and the payment method will be explained with reference to certain example embodiments thereof. However, these example embodiments are not intended to limit the present invention to any specific examples, embodiments, environment, applications, or implementations described in these example embodiments. Therefore, descriptions of these example embodiments is only for purpose of illustration rather than to limit the scope of the present invention.

It shall be appreciated that, in the following embodiments and the attached drawings, elements unrelated to the present invention are omitted from depiction. In addition, dimensions of elements and dimensional relationships among individual elements in the attached drawings are only for the purpose of illustration, but not to limit the scope of the present invention.

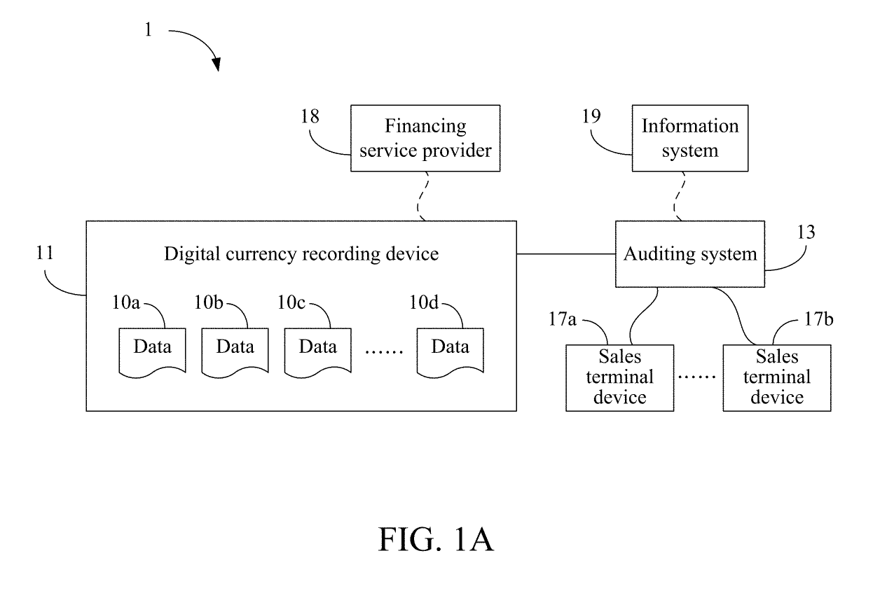

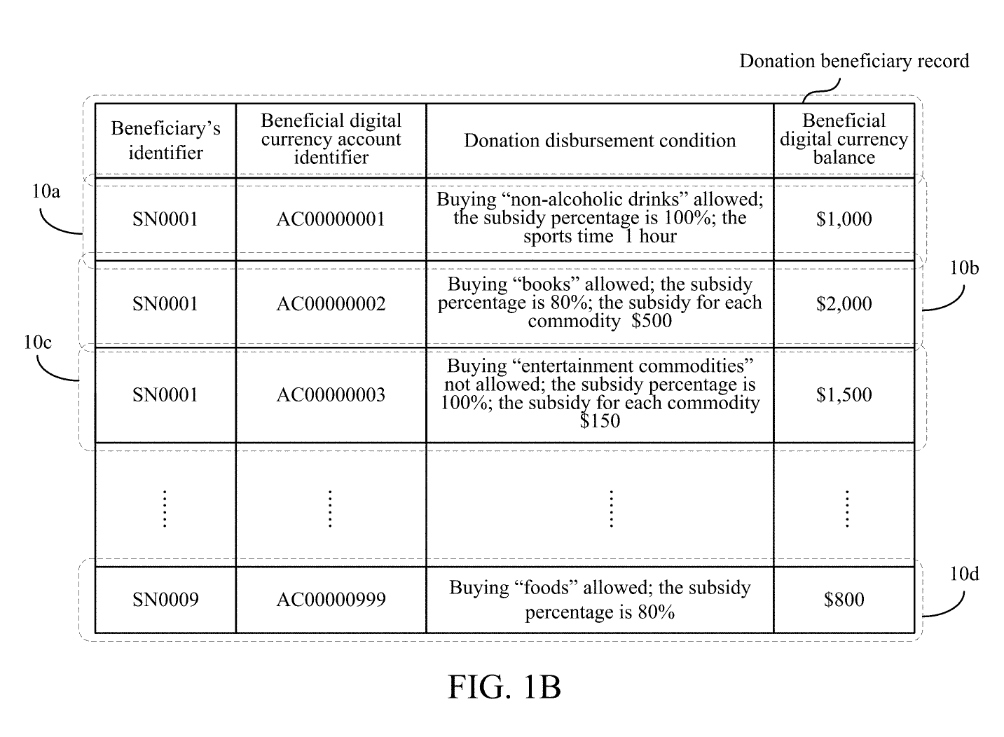

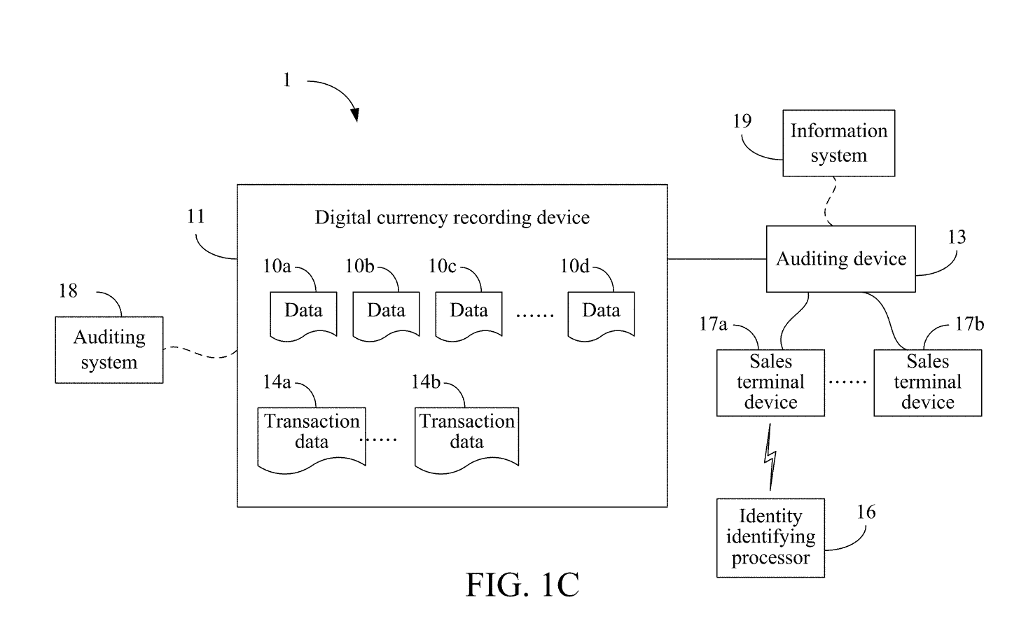

A first embodiment of the present invention is a conditional payment system 1 adopting a digital currency and a schematic framework of which is depicted in FIG. 1A. Although the term “digital currency” is used in the specification and claims of this application, please note that those of ordinary skill in the art will understand that the term “digital currency” may be replaced by other terms such as “digital token,” “electronic token,” “electronic currency,” “virtual token,” “virtual currency,” “encrypted digital token,” and “encrypted digital currency.” The payment system 1 comprises a digital currency recording device 11 and an auditing system 13 electrically connected to the digital currency recording device 11. In this embodiment, each of the digital currency recording device 11 and the auditing system 13 may be a server or some other device with an electronic computation capability. In other embodiments, the digital currency recording device 11 and the auditing system 13 may be integrated into a server or a device with an electronic computation capability.

Briefly speaking, the payment system 1 stores at least a donation beneficial balance of a donation from a donator to a beneficiary and a corresponding donation disbursement condition. The donation disbursement condition may include conditions related to persons (e.g., the beneficiary shall not be under a certain age), things (e.g., the beneficiary shall only consume in some activity (or activities), or a certain behavior of the beneficiary shall meet a certain criteria), the time (e.g., consumption of the beneficiary must or must not take place within a specific time period), places (e.g., consumption of the beneficiary must or must not take place at some place (or places)) or/and objects (e.g., the object purchased by the beneficiary must be or must not be of some specific category (or categories)). Additionally, the donation disbursement condition may further comprise a subsidy percentage and a subsidized fee, wherein the subsidy percentage represents a percentage of the bill of consumption fee at which the donator desires to subsidize the beneficiary. If a consumption of the beneficiary conforms to the donation disbursement condition, the payment system 1 calculates the subsidized fee of this consumption in real time and then pays the subsidized fee of this consumption to the beneficiary from the donation beneficial currency balance. The operations performed by the payment system 1 will be detailed later.

In this embodiment, there are various donation/beneficiary combinations between donators and beneficiaries. From the viewpoint of the donators, one donator may donate to one or more beneficiaries, and one donator may donate one ore more donations to the same beneficiary. From the viewpoint of the beneficiaries, one beneficiary may benefit from one or more donators, and one beneficiary may benefit from one or more donations of the same donator. Donation beneficiary records between the donators and the beneficiaries are stored in the digital currency recording device 11. In this embodiment, the digital currency recording device 11 stores a plurality of data 10a, 10b, 10c, . . . , 10d. It shall be appreciated that the present invention has no limitation on the number of data stored in the digital currency recording device 11. In other words, the digital currency recording device 11 may store only one data in some cases. Each of the data 10a, 10b, 10c, . . . , 10d comprises an identifier of a beneficiary and a beneficiary record related to a donation from a donator to the beneficiary. The beneficiary record comprises a beneficial digital currency account identifier, a donation disbursement condition, and a beneficial digital currency balance.

For ease of understanding, please refer to a specific example depicted in FIG. 1B, which, however, is not intended to limit the scope of the present invention. In this specific example, a donator Alice donates two donation beneficial funds to a beneficiary Bob and the related data of the two donation beneficial funds are recorded in the data 10a and the data 10b respectively. Particularly, the data 10a comprises an identifier of the beneficiary Bob and a donation beneficiary record (including a beneficial digital currency account identifier, a donation disbursement condition, and a beneficial digital currency balance) related to a first donation from the donator Alice to the beneficiary Bob. The data 10b comprises the identifier of the beneficiary Bob and another donation beneficiary record (including a beneficial digital currency account identifier, a donation disbursement condition, and a beneficial digital currency balance) of a second donation from the donator Alice to the beneficiary Bob. The donator Alice also donates a donation beneficial fund to a beneficiary Cindy and the related data of this donation beneficial fund is recorded in the data 10d. Particularly, the data 10d comprises an identifier of the beneficiary Cindy and a donation beneficiary record (including a beneficial digital currency account identifier, a donation disbursement condition, and a beneficial digital currency balance) related to the donation from the donator Alice to the beneficiary Bob. Additionally, the beneficiary Bob has also got a donation beneficial fund from the government (i.e., a donator) and the related data of this donation beneficial fund is recorded in the data 10c. Particularly, the data 10c comprises the identifier of the beneficiary Bob and a donation beneficiary record (including a beneficial digital currency account identifier, a donation disbursement condition, and a beneficial digital currency balance) related to the donation from the donator (i.e., the government) to the beneficiary Bob.

In this embodiment, the payment system 1 is used in combination with the sales terminal devices 17a, . . . , 17b, where each of the sales terminal devices 17a, . . . , 17b may be a Point of Sale (PoS) system, a vending machine, or some other device capable of selling commodities and calculating prices. It shall be appreciated that the present invention has no limitation on the number of sales terminal devices used in combination with the payment system 1. Each of the sales terminal devices 17a, . . . , 17b may be disposed in a store, a pharmacy, a sports center, a scenic spot, a government institute, or some other places selling commodities and/or services, but is not limited thereto. The auditing system 13 of the payment system 1 is electrically connected to the sales terminal devices 17a, . . . , 17b. The auditing system 13 audits consumption of the beneficiary in any of the sales terminal devices 17a, . . . , 17b and decides whether to subsidize this consumption according to the auditing result.

Particularly, when a beneficiary consumes one or more commodities and/or services in any of the sales terminal devices 17a, . . . , 17b, the sales terminal device transmits at least a beneficial digital currency account identifier of the beneficiary, a product identifier of the product consumed by the beneficiary, and a bill of a consumption fee of the commodity/service consumed by the beneficiary to the auditing system 13. When the auditing system 13 determines that the product identifier conforms to the donation disbursement condition corresponding to the beneficial digital currency account identifier and that a subsidized fee related to the consumption fee is not greater than the beneficial digital currency balance corresponding to the beneficial digital currency account identifier, the auditing system 13 subtracts the subsidized fee (i.e., pays the subsidized fee) from the beneficial digital currency balance. It shall be appreciated that if a subsidy percentage is recorded in the donation disbursement condition, the subsidized fee will be the bill of the consumption fee multiplied with the subsidy percentage. If no subsidy percentage is recorded in the donation disbursement condition, the subsidized fee may be the bill of the consumption fee or the bill of consumption fee multiplied with a preset percentage. In some embodiments, the payment system 1 charges a commission. For those embodiments, if a subsidy percentage is recorded in the donation disbursement condition, the subsidized fee will be the bill of consumption fee multiplied with the subsidy percentage plus the commission. If no subsidy percentage is recorded in the donation disbursement condition, the subsidized fee may be the bill of the consumption fee or the bill of the consumption fee multiplied with a preset percentage plus the commission.

For ease of understanding, a specific example will be described with reference to FIG. 1B. It is hereby assumed that the sales terminal device 17a is disposed in a convenience store, and the beneficiary Cindy is to buy bread from the convenience store. The sales terminal device 17a transmits at least the beneficial digital currency account identifier (i.e., AC00000999) of the beneficiary Cindy, a product identifier of the commodity (i.e., bread) consumed by the beneficiary Cindy, and the bill of the consumption fee (e.g., $25) of bread to the auditing system 13. The auditing system 13 retrieves the corresponding donation disbursement condition (i.e., the beneficiary can buy “food” and the subsidy percentage is 80%) according to the received beneficial digital currency account identifier (i.e., AC00000999) and then determines whether the received product identifier conforms to the donation disbursement condition. In this specific example, the product identifier conforms to the donation disbursement condition, so the auditing system 13 further determines whether a subsidized fee (i.e., $25*80%=$20) related to the bill of the consumption fee is not greater than the beneficial digital currency balance (i.e., $800) corresponding to the beneficial digital currency account identifier (i.e., AC00000999). In this specific example, the subsidized fee is not greater than the beneficial digital currency balance, so the auditing system 13 subtracts the subsidized fee (i.e., $20) from the beneficial digital currency balance (i.e., $800). If the beneficiary Cindy also buys a magazine, the sales terminal device 17a will transmit a product identifier of the commodity (i.e., the magazine) consumed by Cindy and the bill of consumption fee (i.e., $100) of the magazine to the auditing system 13. The auditing system 13 then determines whether the received product identifier conforms to the donation disbursement condition. Since the product identifier of the magazine does not conform to the donation disbursement condition, the auditing system 13 will not subsidize the consumption fee of the magazine. In some embodiments, when the auditing system 13 does not subsidize the consumption fee of a certain bill of consumption fee, a transaction failure signal may be transmitted by the auditing system 13 to the sales terminal device so that the operator of the sales terminal device informs the beneficiary that this consumption can not be subsidized.

In this embodiment, if the beneficiary consuming at the sales terminal device 17a, . . . , 17b has more than one donation beneficial fund, the sales terminal device 17a, . . . , 17b may display information related to these donation beneficial funds so that the beneficiary can choose therefrom. For ease of understanding, a specific example will be described with reference to FIG. 1A and FIG. 1B. It is hereby assumed that the sales terminal device 17b is a vending machine and the beneficiary Bob is going to buy a sports drink from the sales terminal device 17b. The sales terminal device 17b may display information related to the two donation beneficial funds from the donator Alice to the beneficiary Bob and the donation beneficial fund from the government to the beneficiary Bob (e.g., beneficiary digital currency account identifiers of the three donation beneficial funds) so that the beneficiary Bob can choose one of the donation beneficial funds to use. It is assumed that the beneficiary Bob chooses the first donation beneficial fund donated by the donator Alice (i.e., the donation beneficial fund corresponding to the data 10a). The sales terminal device 17b transmits at least the identifier of the beneficiary Bob, the beneficial digital currency account identifier of the beneficiary Bob (i.e., AC00000001), the product identifier of the commodity (i.e., the sports drink) consumed by the beneficiary Bob, and the bill of the consumption fee (e.g., $20) of the sports drink to the auditing system 13. The auditing system 13 retrieves the corresponding donation disbursement condition (i.e., the beneficiary can buy “non-alcoholic commodity,” the sports time shall not be shorter than one hour, and the subsidy percentage is 100%) according to the beneficial digital currency account identifier (i.e., AC00000001) and then determines whether this consumption conforms to the donation disbursement condition. In this specific example, the auditing system 13 connects to an information system 19 and determines whether the sports time of the beneficiary Bob is not shorter than one hour according to the identifier of the beneficiary Bob. Additionally, the auditing system 13 determines whether the product identifier conforms to the commodity category recorded in the donation disbursement condition. In this specific example, the sports time of the beneficiary Bob is longer than one hour and the product identifier conforms to the commodity category recorded in the donation disbursement condition, so the auditing system 13 further determines whether a subsidized fee (i.e., $20×100%=$20) related to the bill of consumption fee is not greater than the beneficial digital currency balance (i.e., $1,000) corresponding to the beneficial digital currency account identifier (i.e., AC00000001). In this specific example, the subsidized fee is not greater than the beneficial digital currency balance, so the auditing system 13 subtracts the subsidized fee (i.e., $20) from the beneficial digital currency balance (i.e., $1,000).

In some embodiments if the beneficiary consuming at the sales terminal devices 17a, . . . , 17b has more than one donation beneficial fund, the auditing system 13 of the payment system 1 automatically chooses one or more appropriate donation beneficial funds for payment. Particularly, when a beneficiary consumes one or more commodities and/or services in any of the sales terminal devices 17a, . . . , 17b, the sales terminal device transmits a plurality of beneficial digital currency account identifiers of the beneficiary, a product identifier of the commodity/service consumed by the beneficiary, and a bill of consumption fee of the commodity/service consumed by the beneficiary to the auditing system 13. After receiving the aforesaid information, the auditing system 13 compares the product identifier of the commodity/service consumed by the beneficiary with donation disbursement conditions corresponding to the beneficiary digital currency account identifiers and chooses one or more donation beneficial funds that include the product identifier to pay the subsidized fee related to the bill of the consumption fee.

In some embodiments, the payment system 1 may further cooperate with a financing service provider 18. For those embodiments, if the auditing system 13 determines that the product identifier conforms to the donation disbursement condition but the subsidized fee related to the consumption fee is greater than the beneficial digital currency balance, the beneficiary may send a request regarding an installation payment or a loan from the financing service provider 18. Based on the request of the beneficiary, the financing service provider 18 will pay at least a portion of the consumption fee. Afterwards, the beneficiary has to pay the financing service provider 18 back according to the agreement specified in the request, e.g. the interest rate and the deadline for paying back.

It shall be appreciated that, in some embodiments, the payment system 1 further provides an identification mechanism. Particularly, the user (e.g., a donator, a beneficiary, or a seller) needs to register with the payment system 1 in advance so that the payment system 1 records an identifier of the user in the payment system 1 and the corresponding identification information (or decoding information). The identifier of the user and the corresponding identification information (or decoding information) may be recorded in the digital currency recording device 11, the sales terminal device 17a, . . . , 17b, or other devices included in the payment system 1.

In these embodiments, the sales terminal device 17a, . . . , 17b connects with an identity identifying processor 16. The identity identifying processor 16 may be externally connected to the sales terminal device 17a, . . . , 17b (as shown in FIG. 1C) or built in the sales terminal device 17a, . . . , 17b. The beneficiary inputs identification information (or decoding information) via the identity identifying processor 16. Then, only when the identification information (decoding information) inputted by the beneficiary is consistent with what stored in the payment system 1 will the payment system 1 activate the auditing mechanism. For example, the identity identifying processor 16 may be a keyboard, a fingerprint reader, a video camera, or a handheld electronic device. The beneficiary may input a password via the keyboard, input a fingerprint via the fingerprint reader, input a facial image via the video camera, or show an identification code (e.g., a QR code) on a display screen of the handheld electronic device. Only when the identification information (or decoding information) inputted by the beneficiary is consistent with what stored in the payment system 1, will the payment system 1 activate the auditing mechanism. Once the auditing mechanism of the payment system 1 is activated by the beneficiary in a sales terminal device, the sales terminal device can display information related to one or more donation beneficial funds of the beneficiary for the beneficiary to choose. Then, the auditing system 13 audits the consumption of the beneficiary according to the aforesaid operation mechanism, which will not be detailed again herein.

It shall be appreciated that, in some embodiments, the digital currency recording device 11 stores a plurality of transaction records 14a, . . . , 14b as well as shown in FIG. 1C. Each of the transaction records 14a, . . . , 14b is generated when payment is made from the donation beneficial accounts by any beneficiary at any of the sales terminal devices 17a, . . . , 17b. Each of the transaction records 14a, . . . , 14b may comprise an identifier of a donator, an identifier of a beneficiary, a beneficial digital currency account identifier, a product identifier of a commodity/service consumed by the beneficiary, and a subsidized fee. For those embodiments, the digital currency recording device 11 may connect with an auditing system 18 of a donator. The digital currency recording device 11 may provide transaction records related to the donator to the auditing system 18 either periodically or in response to a request from the donator so that an internal audit may be made by the donator.

In this embodiment, the payment system 1 adopts a centralized or distributed database system. In some embodiments, the payment system 1 may adopt the distributed ledger technology. For those embodiments, the auditing system 13 and the auditing system 18 may be realized by a consensus model and smart contracts and the data 10a, 10b, 10c, . . . , 10d may be stored as a distributed ledger in the digital currency recording device 11. A person having ordinary skill in the art shall understand how the distributed ledger technology works; hence, the details are not described herein.

According to the above description, the digital currency recording device 11 of the payment system 1 stores at least the donation beneficial currency balance donated by the donator to the beneficiary and the corresponding donation disbursement condition. If a consumption of the beneficiary conforms to the donation disbursement condition, the payment system 1 pays the subsidized fee of this consumption of the beneficiary from the donation beneficial currency balance in real time. When the payment system 1 is used with the sales terminal devices 17a, . . . , 17b, conveniences and timeliness achieved by the payment system will become more prominent. With the payment system 1 according to this embodiment, the beneficiary does not need to advance the consumption fee of the consumed commodity and/or service. Moreover, the donator can utilize the auditing system 13 to audit whether the beneficiary's consumption conforms to the donation disbursement condition to avoid waste of the subsidy by the beneficiary.

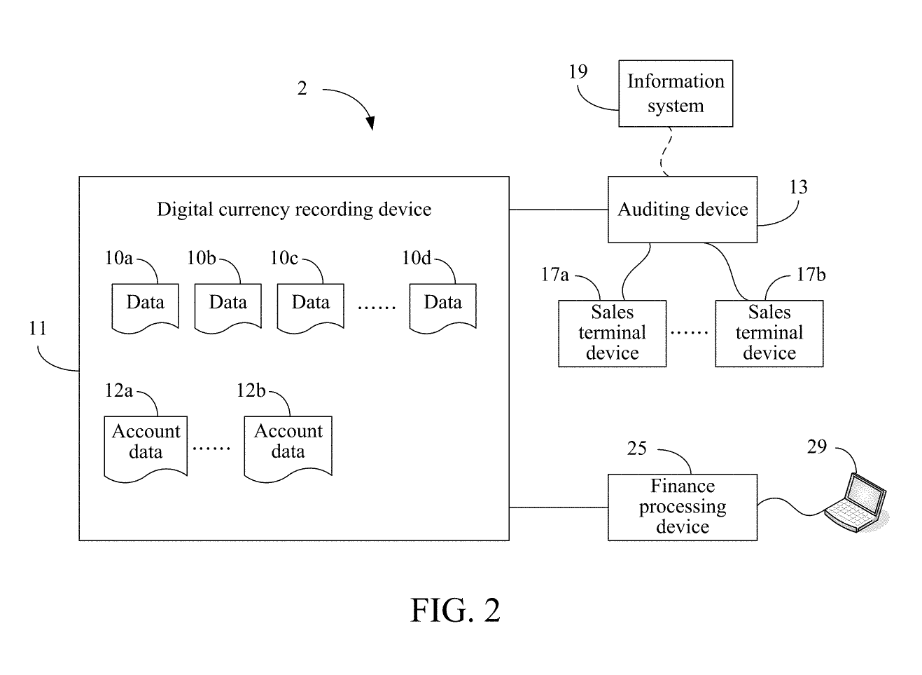

A second embodiment of the present invention is a payment system 2 adopting a digital currency and a schematic framework of which is depicted in FIG. 2. The payment system 2 comprises a digital currency recording device 11, an auditing system 13, and a finance processing device 25, wherein the auding device 13 and the finance processing device 25 are electrically connected to the digital currency recording device 11. In this embodiment, each of the digital currency recording device 11, the auditing system 13, and the finance processing device 25 may be a server or some other device with an electronic computation capability. In other embodiments, any combination of the digital currency recording device 11, the auditing system 13, and the finance processing device 25 may be integrated into a server or a device with an electronic computation capability. In this embodiment, the digital currency recording device 11 and the auditing system 13 can execute all operations, have the same functions, and deliver the same effect described in the first embodiment and, hence, those details will not be further described herein. Hereinbelow, only the differences from the first embodiment will be described.

In this embodiment, the digital currency recording device 11 further stores a plurality of account data 12a, . . . , 12b, wherein each of the account data 12a, . . . , 12b comprises an identifier, a digital currency account identifier, and a digital currency balance of a donator, a beneficiary, or a seller (e.g., an owner of any of the sales terminal devices 17a, . . . , 17b). The donator may connect to the finance processing device 25 via a user terminal device (e.g., a personal computer, a notebook computer, a tablet computer, a mobile device, or the like) to make donation settings. Particularly, the donator has to input his or her own identifier, the identifier of the beneficiary, the beneficial digital currency account identifier (i.e., the identifier of the beneficial digital currency account with which the donator donates the beneficiary), the donation disbursement condition, and the beneficial digital currency balance (i.e., the digital currency amount to be donated) into the finance processing device 25. After receiving the aforesaid information, the finance processing device 25 stores the identifier of the beneficiary, the beneficial digital currency account identifier, the donation disbursement condition, and the beneficial digital currency balance and subtracts the beneficial digital currency balance from the digital currency balance of the donator.

For ease of understanding, a specific example will be described with reference to FIG. 1B and FIG. 2, which, however, is not intended to limit the scope of the present invention. In this specific example, the donator Alice has a digital currency account, and the digital currency account has a digital currency account identifier and a digital currency balance. The account data 12a is the account data of the donator Alice, which comprises an identifier, a digital currency account identifier, and a digital currency balance of the donator Alice. The donator Alice connects to the finance processing device 25 via a user terminal 29 and inputs her own identifier, the identifier (i.e., SN0001) of the beneficiary Bob, the beneficial digital currency account identifier (i.e., AC00000001), the donation disbursement condition (i.e., the product category is milk, the amount is no greater than $30, and the subsidy percentage is 100%), and beneficial digital currency balance (i.e., $1,000) into the finance processing device 25 via the user terminal device 29. After receiving the aforesaid information, the finance processing device 25 stores the identifier (i.e., Bob) of the beneficiary Bob, the beneficial digital currency account identifier (i.e., AC00000001), the donation disbursement condition (i.e., the product category is milk, the fee is no greater than $30, and the subsidy percentage is 100%), and beneficial digital currency balance (i.e., $1,000) as the data 10a. Additionally, the finance processing device 25 subtracts the beneficial digital currency balance from the digital currency balance of the donator Alice. Through the aforesaid operations, setting of the first donation beneficial fund from the donator Alice to the beneficiary Bob is completed.

In this embodiment, the seller corresponding to any of the sales terminal device 17a, . . . , 17b has an account data as described above. When a beneficiary consumes one or more commodities and/or services at any of the sales terminal device 17a, . . . , 17b, the sales terminal device transmits at least the digital currency account identifier of the seller corresponding to the sales terminal device, a beneficial digital currency account identifier of the beneficiary, a product identifier of the commodity/service consumed by the beneficiary, and a bill of the consumption fee of the commodity/service consumed by the beneficiary to the auditing system 13. When the auditing system 13 determines that the product identifier conforms to the donation disbursement condition corresponding to the beneficial digital currency account identifier and that a subsidized fee related to the bill of the consumption fee is not greater than the beneficial digit currency balance corresponding to the beneficial digital currency account identifier, the auditing system 13 subtracts the subsidized fee (i.e., pay the subsidized fee) from the beneficial digital currency balance. In addition, the auditing system 13 adds the subsidized fee to the digital currency balance of the digital currency account of the seller according to the digital currency account identifier of the seller.

In some embodiments, the donator may suspend his or her donation to the beneficiary at any time. In such embodiments, when the donator requests to suspend a donation for a beneficiary, the finance processing device 25 adds the beneficial digital currency balance (which is in the data corresponding to the donation beneficial fund) to the digital currency balance of the donator and zeros the beneficial digital currency balance in the data. Additionally, in some embodiments, the donator may set a fund recall condition (e.g., a specified time limit) for the donation beneficial fund that he or she provides to the beneficiary. In such embodiments, the financial processing device 25 determines whether the data corresponding to the donation beneficial fund provided by the donator to the beneficiary conforms to the fund recall condition. If the data conforms to the fund recall condition, the finance processing device 25 adds the beneficial digital currency balance in the data to the digital currency balance of the donator corresponding to the data and zeros the beneficial digital currency balance in the data.

For ease of understanding, a specific example will be described with reference to FIG. 1B, which, however, is not intended to limit the scope of the present invention. It is hereby assumed that the donator Alice sets a fund recall condition for the donation beneficial fund corresponding to the data 10a, wherein the fund recall condition is “a time limit of 30 days.” The finance processing device 25 periodically (e.g., at 9:00 am everyday) determines whether the donation beneficial fund corresponding to the data 10a conforms to the fund recall condition. If the donation beneficial fund corresponding to the data 10a conforms to the fund recall condition, the finance processing device 25 adds the beneficial digital currency balance in the data 10a to the digital currency balance of the donator Alice and zeros the beneficial digital currency balance in the data 10a.

According to the above description, the finance processing system 25 of the payment system 2 is responsible for management of the digital currency accounts of the payment system, the donator, the beneficiary, and the seller. By means of the finance processing device 25, the donator can set and suspend donations conveniently.

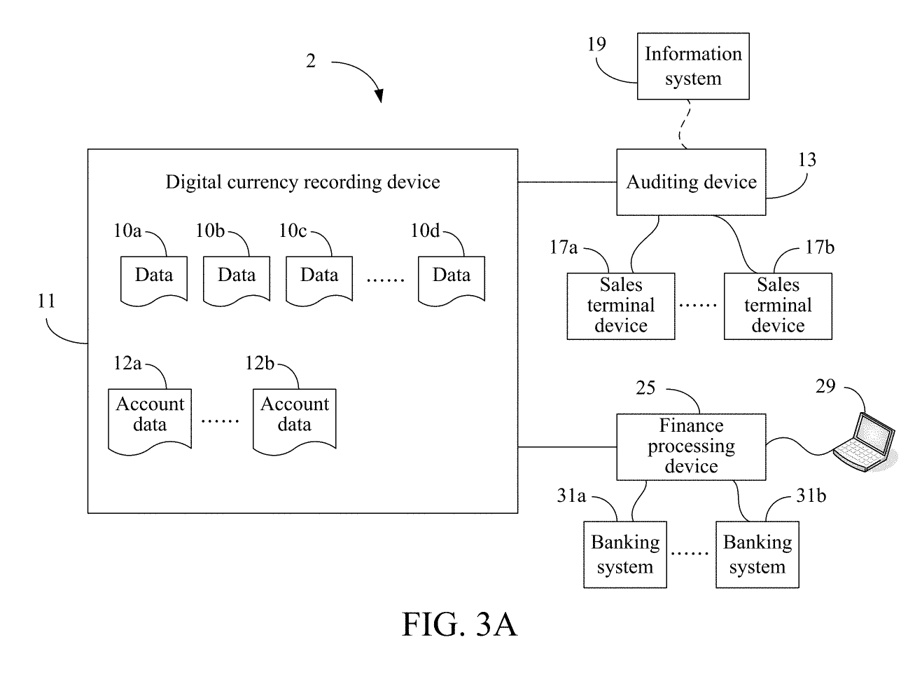

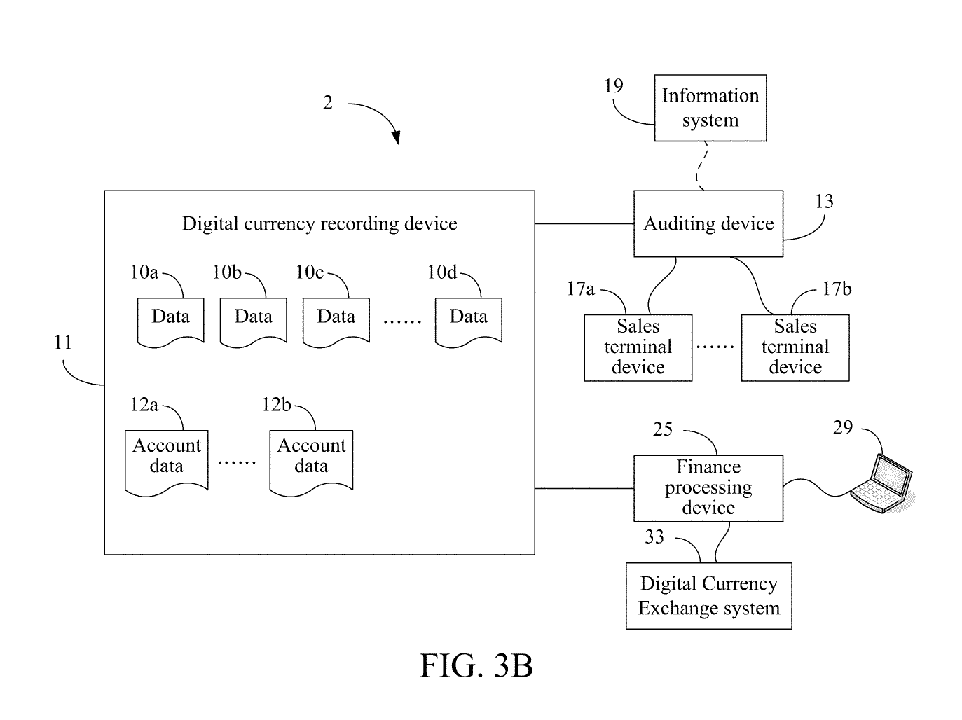

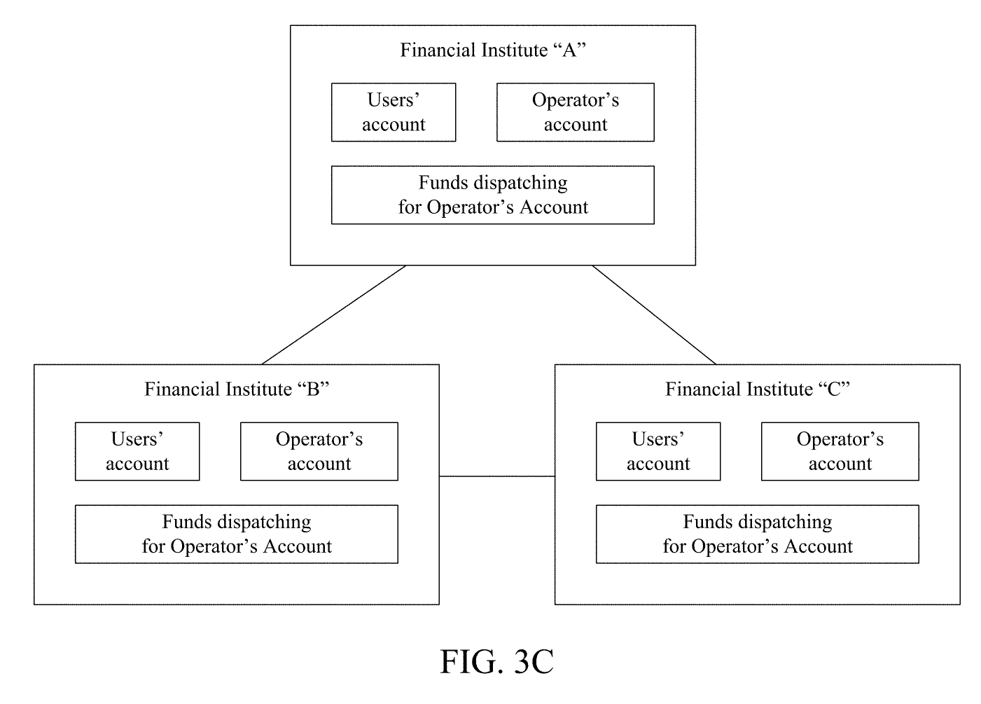

A third embodiment of the present invention is depicted in FIG. 3A. In this embodiment, the digital currency recording device 11, the auditing system 13, and the finance processing device 25 can execute all the operations, have the same functions, and deliver the same effects described in the first and the second embodiments and, hence, the details will not be described again herein. Hereinbelow, only the differences from the first and the second embodiments will be detailed.

In this embodiment, the finance processing device 25 of the payment system 2 further connects to a plurality of banking systems 31a, . . . , 31b. It shall be appreciated that the present invention has no limitation on the number of banking systems 31a, . . . , 31b connected with the finance processing device 25, and the banking systems 31a, . . . , 31b may belong to different financial institutes. The banking systems 31a, . . . , 31b adopt a fiat currency, while the payment system 2 adopts the digital currency. The digital currency corresponds to the fiat currency at an exchange rate, which may be preset or determined by the market.

In this embodiment, since the finance processing device 25 of the payment system 2 connects to the banking systems 31a, . . . , 31b, the payment system 2 may exchange the fiat currency and the digital currency with each other in response to an operation of a user (e.g., the donator, the beneficiary, or the seller). There may be several kinds of exchange between the fiat currency and the digital currency. The first kind of exchange happens when the user uses the digital currency for deposition, the second kind of exchange happens when the donator sets the donation, and the third kind of exchange happens when the withdrawer (e.g., the donator, or the seller) withdraws the digital currency.

Now the first kind of exchange (i.e., the exchange between the fiat currency and the digital currency that happens when the user uses the digital currency for deposition) will be described. As described above, each of the account data 12a, . . . , 12b stored in the digital currency recording device 11 comprises an identifier, a digital currency account identifier, and a digital currency balance of a donator, a beneficiary, or a seller (e.g., an owner of any of the sales terminal devices 17a, . . . , 17b). When a user (e.g., the donator, the beneficiary, or the seller) requests to deposit a digital currency amount, the finance processing device 25 calculates a fiat currency amount corresponding to the digital currency amount according to an exchange rate, subtracts the fiat currency amount from fiat currency balance of a fiat currency account of the user, adds the fiat currency amount to fiat currency balance of a fiat currency account of the operation institute that operates the payment system 2, and adds the digital currency amount to the digital currency balance in the account data of the user.

Then, the second kind of exchange (i.e., the exchange between the fiat currency and the digital currency that happens when the donator makes settings for donation) will be described. In the aforesaid second embodiment, the donator may connect to the finance processing device 25 via a user terminal device to make settings for donation. The donator needs to input his or her own identifier, the identifier of the beneficiary, the beneficial digital currency account identifier (i.e., the identifier of the beneficial digital currency account with which the donator donates the beneficiary), the donation disbursement condition, and the beneficial digital currency balance (i.e., the digital currency amount to be donated) into the finance processing device 25. In this embodiment, after receiving the aforesaid information, the finance processing device 25 allocates funds from the fiat currency account of the donator. Particularly, the finance processing device 25 calculates beneficial fiat currency balance corresponding to the beneficial digital currency balance according to an exchange rate, subtracts the beneficial fiat currency balance from fiat currency balance of the fiat currency account of the donator, adds the beneficial fiat currency balance to fiat currency balance of an operation institute that operates the payment system 2, adds the digital currency balance to digital currency balance in the account data of the donator, stores the identifier of the beneficiary, the beneficial digital currency account identifier, the donation disbursement condition, and the beneficial digital currency balance, and subtracts the beneficial digital currency balance from the digital currency balance of the donator.

In some embodiments, the finance processing device 25 of the payment system 2 may connects to a digital currency exchanging system 33 as shown in FIG. 3B. For those embodiments, the donator also needs to input his or her own identifier, the identifier of the beneficiary, the beneficial digital currency account identifier (i.e., the identifier of the beneficial digital currency account with which the donator donates the beneficiary), the donation disbursement condition, and the beneficial digital currency balance (i.e., the digital currency amount to be donated) into the finance processing device 25. In those embodiments, the beneficial digital currency balance (i.e., the digital currency amount to be donated) corresponds to a first digital currency type, and the finance processing device 25 allocates funds from a digital account of a second digital currency type of the donator. Specifically, the finance processing device 25 calculates another beneficial digital currency balance corresponds to the beneficial digital currency balance according to an exchange rate, wherein the another beneficial digital currency balance corresponds to a second digital currency type. Then, the finance processing device 25 perform the following operations: (a) subtracts the another beneficial digital currency balance from a digital currency balance of the second digital currency type of the donator, (b) adds the another beneficial digital currency balance to a digital currency balance of the second digital currency type of an operation institute of the payment system 2, (c) adds the aforesaid beneficial digital currency balance to a digital account of the first digital currency type of the donator, (d) stores the identifier of the beneficiary, the beneficial digital currency account identifier, the donation disbursement condition, and the beneficial digital currency balance, and (e) subtracts the beneficial digital currency balance from the digital account of the first digital currency type of the donator.

Next, the third kind of exchange (i.e., the exchange between the fiat currency and the digital currency that happens when a withdrawer (which may be the seller or the donator) withdraws the digital currency) will be described. An exemplary architecture of which is illustrated in FIG. 3C. When a withdrawer (e.g., the donator or the seller) makes a request to the finance processing device 25 regarding withdrawal of a withdrawal fiat currency amount to a fiat currency account of the withdrawer in a financial institute (e.g., a financial institute “A”), the finance processing device 25 determines whether fiat currency balance of the operation institute that operates the payment system 2 in the same financial institute (e.g., the financial institute “A”) is greater than or equal to the withdrawal fiat currency amount.

If the fiat currency balance of the operation institute that operates the payment system 2 in the same financial institute (e.g., the financial institute “A”) is greater than or equal to the withdrawal fiat currency amount, the finance processing device 25 adds the withdrawal fiat currency amount to fiat currency balance of the withdrawer in the financial institute, subtracts the withdrawal fiat currency amount from the fiat currency balance of the operation institute that operates the payment system 2 in the financial institute, and subtracts a withdrawal digital currency amount from digital currency balance of a digital currency account of the withdrawer, where the withdrawal digital currency amount corresponds to the withdrawal fiat currency amount according to a preset percentage.

If the fiat currency balance of the operation institute that operates the payment system 2 in the same financial institute (e.g., the financial institute “A”) is smaller than the withdrawal fiat currency amount, the finance processing device 25 transfers a fiat currency amount from another financial institute (e.g., a financial institute “B”) that charges the minimum transferring commission. Particularly, the finance processing device 25 subtracts a transferred amount and a commission amount from the fiat currency balance of the operation institute that operates the payment system 2 in another financial institute (e.g., the financial institute “B”), adds the transferred amount to the fiat currency balance of the operation institute that operates the payment system 2 in the same financial institute (e.g., the financial institute “A”), adds the withdrawal fiat currency amount to the fiat currency balance of the withdrawer in the same financial institute, subtracts a withdrawal fiat currency amount from the fiat currency balance of the operation institute that operates the payment system 2 in the same financial institute, and subtracts a withdrawal digital currency amount from a digital currency amount of a digital currency account of the withdrawer, where the withdrawal digital currency amount corresponds to the withdrawal fiat currency amount according to a preset percentage.

In some embodiments, a beneficiary may be a withdrawer. In those embodiments, the finance processing device 25 will determine whether the withdrawer is a beneficiary. If the withdrawer is a beneficiary, the finance processing device 25 will further determine whether the withdrawer has accomplished a task specified in the donation disbursement condition. Only when the withdrawer has accomplished the task specified in the donation disbursement condition will the finance processing device 25 let the withdrawer withdraw money according to the aforementioned approach.

According to the above description, when the finance processing device 25 of the payment system 2 connects to the banking system 31a, . . . , 31b, the payment system 2 can exchange the fiat currency and the digital currency between each other in response to operations of the user (e.g., the donator, the beneficiary, or the seller) so that the payment system 2 can be used by the user more conveniently.

According to the description of the third embodiment, those of ordinary skill in the art shall appreciate that the finance processing device 25 of the payment system 2 may also connect to information systems of different financial institutes/stores (e.g., information systems of credit card companies) in some other embodiments. In such embodiments, the payment system 2 may exchange reward points issued by the financial institutes/stores and the digital currency with each other in response to operations of the user (e.g., the donator, the beneficiary, or the seller). The digital currency corresponds to the reward points issued by the financial institutes/stores according to respective exchange rates, which may be preset. How the exchange between the reward points issued by the financial institutes/stores and the digital currency is made by the payment system 2 can be understood by those of ordinary skill in the art from the description of the third embodiment, so this will not be further described herein.

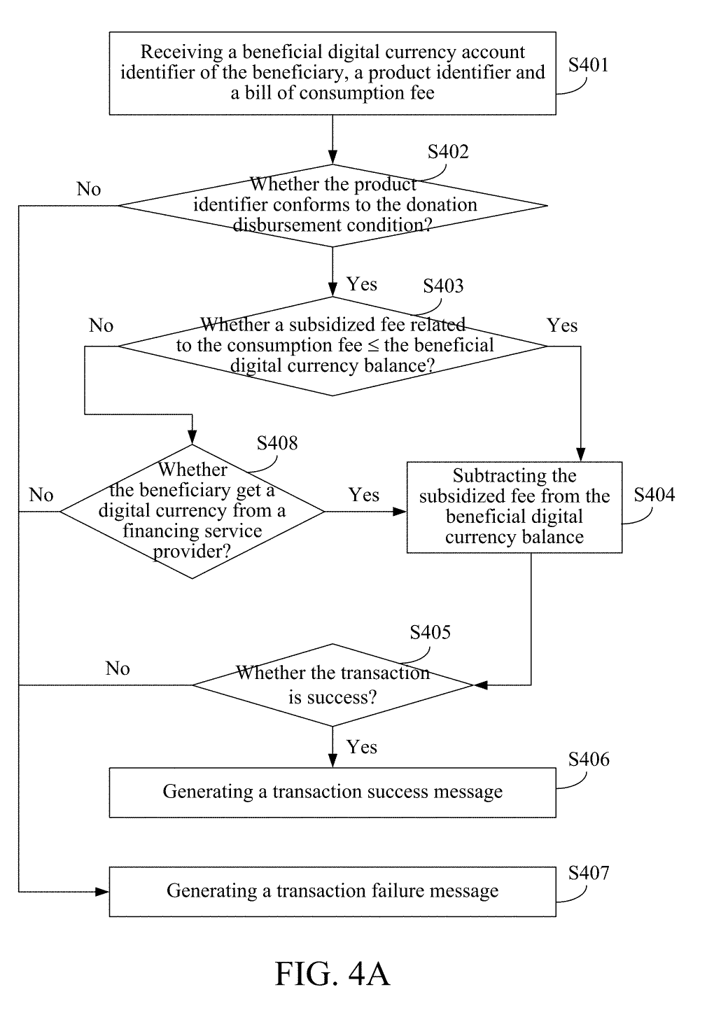

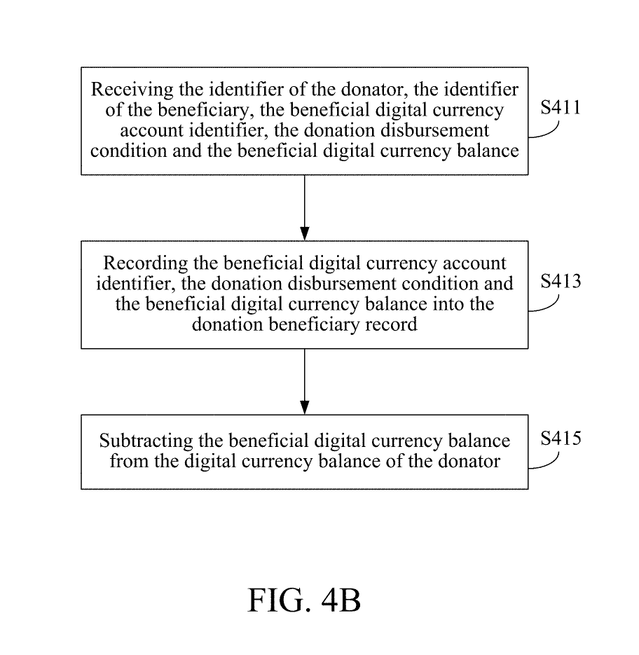

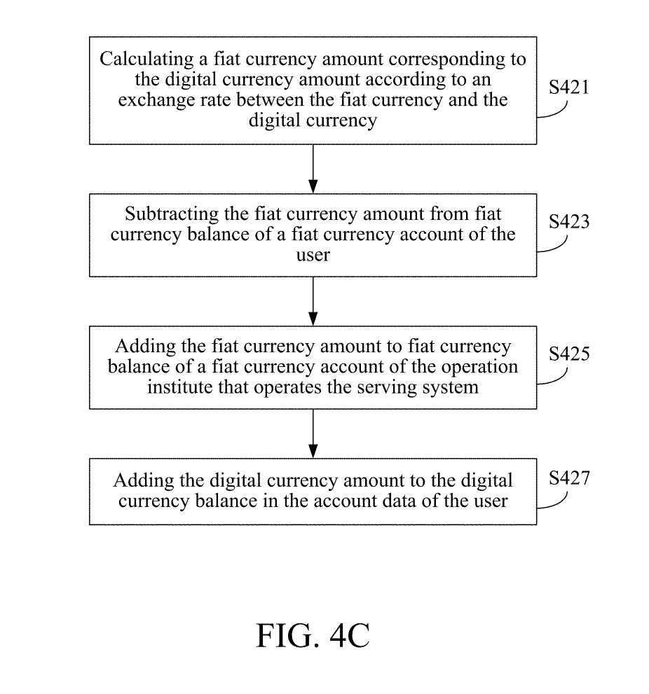

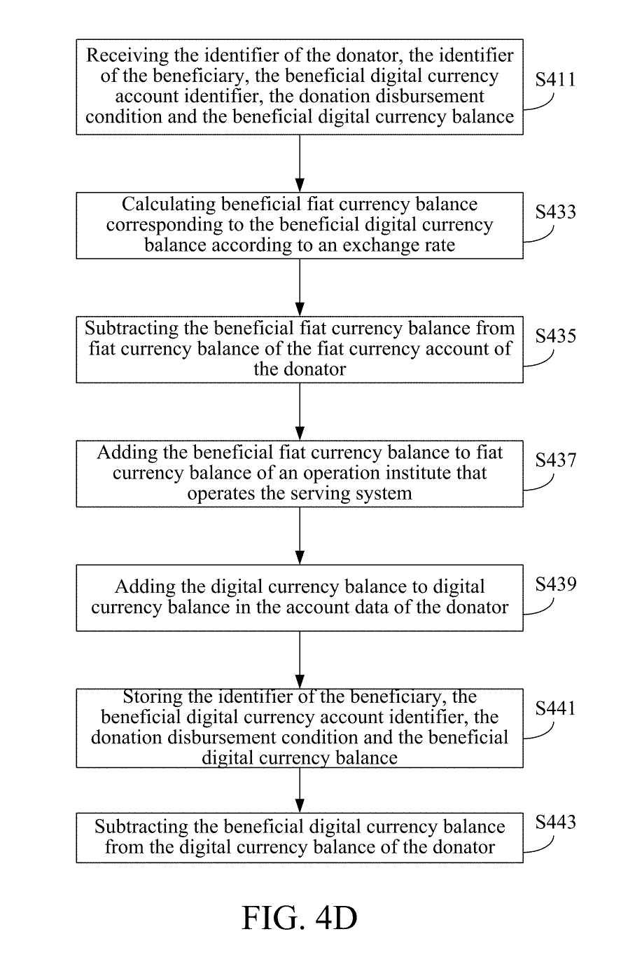

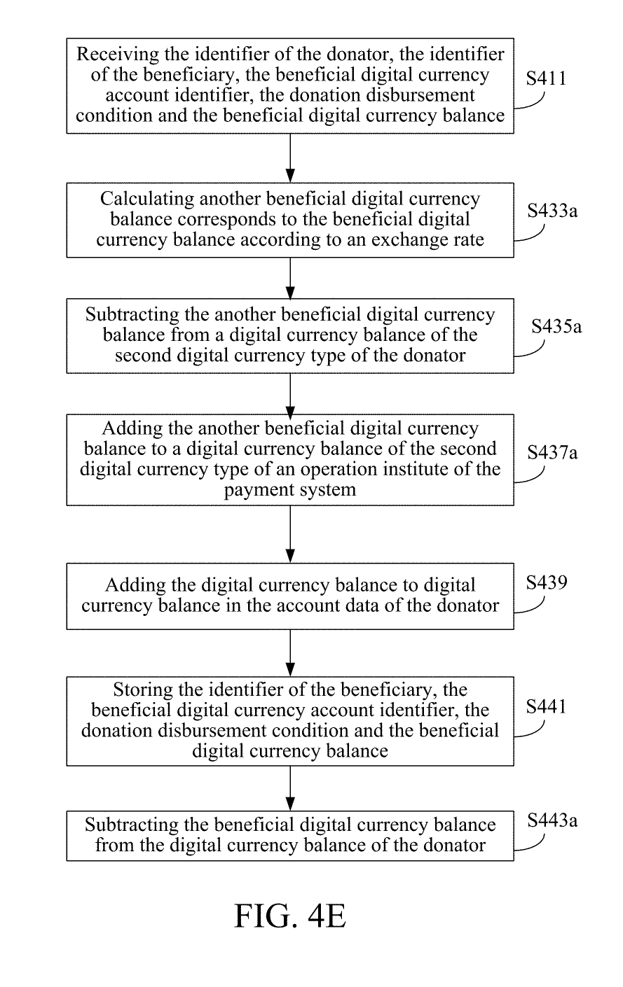

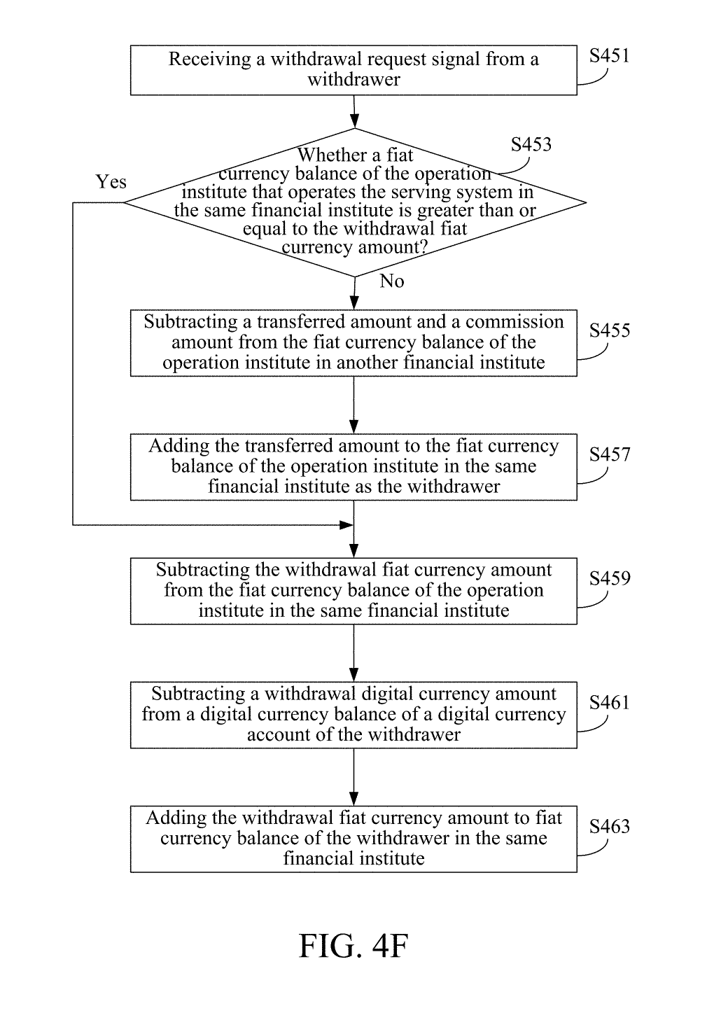

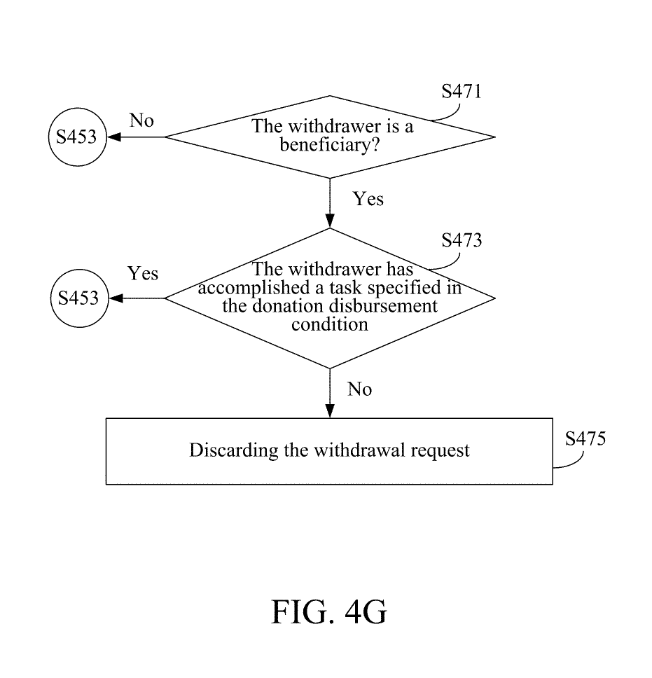

A fourth embodiment of the present invention is a payment method adopting a digital currency, whose flowchart is depicted in FIG. 4A. The payment method is adapted for a serving system, which comprises one or more servers. The serving system stores an identifier of a beneficiary and a donation beneficiary record that is related to a donation from a donator to the first beneficiary, where the donation beneficiary record comprises a beneficial digital currency account identifier, a donation disbursement condition, and a beneficiary digital currency balance.

First in step S401, the beneficial digital currency account identifier of the beneficiary, a product identifier, and a bill of a consumption fee are received by the serving system from a sales terminal device. In step S402, the serving system determines whether the product identifier conforms to the donation disbursement condition. If the determination result of the step S402 is no (i.e., the product identifier does not conform to the donation disbursement condition), step S407 is executed by the serving system to generate a transaction failure message (which may indicate that the reason causing the failure is nonconformity of the product identifier to the donation disbursement condition) to indicate that this consumption will not be subsidized. If the determination result of the step S402 is yes (i.e., the product identifier conforms to the donation disbursement condition), step S403 is executed by the serving system to determine whether a subsidized fee related to the consumption fee is not greater than the beneficial digital currency balance.

In this embodiment, if the determination result of the step S403 is no (i.e., the subsidized fee is greater than the beneficial digital currency balance), step S408 is executed to determine whether the beneficiary get a digital currency (e.g. installment payment, loan) from a financing service provider. If the determination result of step S408 is no, step S407 is executed by the serving system to generate a transaction failure message (which may indicate that the reason causing the failure is that the subsidized fee is greater than the beneficial digital currency balance) to indicate that this consumption is not subsidized. If the determination result of step S408 is yes, step S404 is executed by the serving system to subtract the subsidized fee from the beneficial digital currency balance by the serving system and then step S405 is executed by the serving system to determine whether this transaction is successful. Please note that the step S408 may be skipped in other embodiments. For those embodiments, if the determination result of the step S403 is no, the payment method proceeds to the step S407.

If the determination result of the step S403 is yes (i.e., the subsidized fee is not greater than the beneficial digital currency balance), step S404 is executed by the serving system to subtract the subsidized fee from the beneficial digital currency balance by the serving system and then step S405 is executed by the serving system to determine whether this transaction is successful. If the determination result of the step S405 is no, step S407 is executed by the serving system to generate a transaction failure message (which may indicate the reason causing the failure, e.g., network disconnection) to indicate that this consumption is not subsidized. If the determination result of the step S405 is yes, step S406 is executed by the serving system to generate a transaction success message.

It shall be appreciated that the payment method according to this embodiment also applies to a case where one donator donates one or more donation beneficial funds to a same beneficiary, a case where one donator donates a plurality of beneficiaries, a case where one beneficiary benefits from a plurality of donators, and a case where one beneficiary benefits from a plurality of donation beneficial funds from a same donator. In such cases, the serving system stores a plurality of pieces of data, each of the data comprises an identifier of a beneficiary and a beneficiary record related to a donation from a donator to the beneficiary. The beneficiary record comprises a beneficial digital currency account identifier, a donation payment condition, and a beneficial digital currency balance. How the payment method decides whether to subsidize a consumption of a beneficiary when a plurality of data is stored in the serving system can be understood by those of ordinary skill in the art from descriptions of the first embodiment and the aforesaid steps S401 and S409, so the details will not be further described herein.

In some embodiments, the payment method may execute a donation setting process shown in FIG. 4B, which is executed before the process of FIG. 4A. In such embodiments, the serving system further stores an identifier, a digital currency account identifier, and digital currency balance of the donator. In step S411, the identifier of the donator, the identifier of the beneficiary, the beneficial digital currency account identifier, the donation disbursement condition, and the beneficial digital currency balance are received by the serving system. Then, in step S413, the beneficial digital currency account identifier, the donation disbursement condition, and the beneficial digital currency balance are recorded into the donation beneficiary record by the serving system. Next in step S415, the beneficial digital currency balance is subtracted by the serving system from the digital currency balance of the donator. Through the aforesaid steps S411, S413 and S415, the donation setting can be completed.

In some embodiments, the donator may suspend his or her donation to the beneficiary at any time. In such embodiments, the payment method may execute a step in which the serving system receives a donation suspend request to suspend a donation beneficial fund. The payment method may further execute a step in which the serving system adds the beneficial digital currency balance, which is in the data corresponding to the donation beneficial fund, i to the digital currency balance of the donator and execute another step in which the serving system zeros the beneficial digital currency balance in the data. Additionally, in some embodiments, the donator may set a fund recall condition (e.g., a specified time limit) for the donation beneficial fund that he or she provides to the beneficiary. In such embodiments, the payment method executes a step in which it is determined whether the data corresponding to the donation beneficial fund provided by the donator to the beneficiary conforms to the fund recall condition. If the data conforms to the fund recall condition, the payment method executes the aforesaid steps to recall the donation beneficial fund that the donator provides to the beneficiary.

In some embodiments, the seller corresponding to the sales terminal device may request payment from the serving system. In such embodiments, the payment method may execute a step in which the serving system accepts a payment request from a seller. The payment method further executes a step in which the serving system subtracts a payment-request digital currency amount from a digital currency total amount of the serving system according to the payment request and executes another step in which the serving system adds the payment-request digital currency amount to a digital currency balance of the digital currency account of the seller.

In some embodiments, the payment method may further execute a process of exchanging between the fiat currency and the digital currency. There are several kinds of exchanges between the fiat currency and the digital currency. The first kind of exchange happens when the user uses the digital currency for deposition, the second kind of exchange happens when the donator sets the donation, and the third kind of exchange happens when the withdrawer (e.g., the donator, or the seller) withdraws the digital currency.

Now, the first kind of exchange (i.e., the exchange between the fiat currency and the digital currency that happens when the user uses the digital currency for deposition) will be described, whose flowchart is depicted in FIG. 4C. When a user (e.g., the donator, the beneficiary, or the seller) requests to deposit a digital currency amount, the payment method may execute step S421 in which the serving system calculates a fiat currency amount corresponding to the digital currency amount according to an exchange rate between the fiat currency and the digital currency. Then, in step S423, the serving system subtracts the fiat currency amount from fiat currency balance of a fiat currency account of the user. Next, in step S425, the serving system adds the fiat currency amount to a fiat currency balance of a fiat currency account of the operation institute that operates the serving system. Then, in step S427, the serving system adds the digital currency amount to the digital currency balance in the account data of the user.

Then, the second kind of exchange (i.e., the exchange between the fiat currency and the digital currency that happens when the donator makes settings for donation) will be described, whose flowchart is depicted in FIG. 4D. First, in step S411, the serving system receives the identifier of the donator, the identifier of the beneficiary, the beneficial digital currency account identifier, the donation disbursement condition, and the beneficial digital currency balance. Then, in step S433, the serving system calculates the beneficial fiat currency balance corresponding to the beneficial digital currency balance according to an exchange rate. Next, in step S435, the serving system subtracts the beneficial fiat currency balance from a fiat currency balance of the fiat currency account of the donator. In step S437, the serving system adds the beneficial fiat currency balance to a fiat currency balance of an operation institute that operates the serving system. In step S439, the serving system adds the digital currency balance to a digital currency balance in the account data of the donator. Next, in step S441, the serving system stores the identifier of the beneficiary, the beneficial digital currency account identifier, the donation disbursement condition, and the beneficial digital currency balance, which means that the serving system allocates the beneficial digital currency balance to the beneficiary. Then, in step S443, the serving system subtracts the beneficial digital currency balance from the digital currency balance of the donator.

In some embodiments, the second kind of exchange can be achieved by the steps illustrated in FIG. 4E. For those embodiments, step S411 is also executed, wherein the beneficial digital currency balance corresponds to a first digital currency type. Then, step S433a is executed for calculating another beneficial digital currency balance corresponds to the beneficial digital currency balance according to an exchange rate, wherein the another beneficial digital currency balance corresponds to a second digital currency type. Next step S435a is executed for subtracting the another beneficial digital currency balance from a digital currency balance of the second digital currency type of the donator. Following that, step S437a is executed for adding the another beneficial digital currency balance to a digital currency balance of the second digital currency type of an operation institute of the payment system. In addition, steps S439, S441, and S443a are executed.

Next, the third kind of exchange (i.e., the exchange between the fiat currency and the digital currency that happens when a withdrawer withdraws the digital currency) will be described whose flowchart is depicted in FIG. 4F. First, in step S451, the serving system receives a withdrawal request signal from a withdrawer, wherein the withdrawal request signal represents that the withdrawer requests to withdraw a withdrawal fiat currency amount to a fiat currency account of the withdrawer in a financial institute (e.g., a financial institute “A”). Then, in step S453, the serving system determines whether a fiat currency balance of the operation institute that operates the serving system in the same financial institute (e.g., the financial institute “A”) is greater than or equal to the withdrawal fiat currency amount.

If the determination result of the step S453 is no, the serving system transfers a fiat currency amount from another financial institute (e.g., a financial institute “B”) that charges the minimum transferring commission. Particularly, in step S455, the serving system subtracts a transferred amount and a commission amount from the fiat currency balance of the operation institute that operates the serving system in another financial institute (e.g., the financial institute “B”). In step S457, the serving system adds the transferred amount to the fiat currency balance of the operation institute in the same financial institute (e.g., the financial institute “A”) as the withdrawer. Next, in step S459, the serving system subtracts the withdrawal fiat currency amount from the fiat currency balance of the operation institute in the same financial institute. In step S461, the serving system subtracts a withdrawal digital currency amount from a digital currency balance of a digital currency account of the withdrawer, wherein the withdrawal digital currency amount corresponds to the withdrawal fiat currency amount according to a preset percentage. In step S463, the serving system adds the withdrawal fiat currency amount to a fiat currency balance of the withdrawer in the same financial institute. If the determination result of the step S453 is yes, the serving system executes the steps S459, S461 and S463 directly.

In some embodiments, the steps illustrate in FIG. 4G may be further executed by the payment method for the third kind of exchange in addition to the steps shown in FIG. 4F. For those embodiments, after the step S451, step S471 is executed for determining whether the withdrawer is a beneficiary. If the determination result of step S471 is not, the payment method proceeds to step S453. If the determination result of step S471 is yes, the payment method executes step S473 for determining whether the withdrawer has accomplished a task specified in the donation disbursement condition. If the determination result of the step S473 is yes, the payment method proceeds to step S453. If the determination result of the step S473 is no, the payment method executes the step 475 to discard the withdrawal request signal.

From the descriptions of FIG. 4C, FIG. 4D, FIG. 4E, FIG. 4F, and FIG. 4G, those of ordinary skill in the art shall appreciate that the serving system executing the payment method may also connect to information systems of different financial institutes/stores (e.g., information systems of credit card companies) in some embodiments. In such embodiments, the serving system that executes the payment method may exchange reward points issued by the financial institutes/stores and the digital currency with each other in response to operations of the user (e.g., the donator, the beneficiary, or the seller). The digital currency corresponds to the reward points issued by the financial institutes/stores according to respective exchange rates, which may be preset. Regarding how the serving system executing the payment method can achieve the exchange between the reward points issued by the financial institutes/stores and the digital currency, those of ordinary skill in the art shall appreciate the details from the description of the third embodiment. Therefore, the details will not be further described herein.

In addition to the aforesaid steps, the fourth embodiment can also execute all the operations and steps set forth in the first to the third embodiments, have the same functions, and deliver the same technical effects as the first to the third embodiments. How the fourth embodiment executes these operations and steps, has the same functions, and delivers the same technical effects as the first to the third embodiments will be readily appreciated by those of ordinary skill in the art based on the explanation of the first to the third embodiments, and thus will not be further described herein.

According to the above descriptions, the payment system and method of the present invention store at least the donation beneficial currency balance donated by the donator to the beneficiary and the corresponding donation disbursement condition. If a consumption of the beneficiary conforms to the donation disbursement condition, the payment system pays the subsidized fee of this consumption of the beneficiary from the donation beneficial currency balance in real time. With the payment system and the payment method according to the present invention, the beneficiary does not have to advance the consumption fee of the consumed commodity and/or service and the donator can audit whether the beneficiary's consumption conforms to the donation disbursement condition to avoid waste of the subsidy by the beneficiary.

When the payment system and the payment method of the present invention are used in combination with a sales terminal device, conveniences and timeliness achieved by the payment system will become more prominent. Additionally, the payment system of the present invention can also be responsible for management of digital currency accounts of the payment system, the donator, the beneficiary, and the seller. The donator can conveniently set and suspend the donation, and the seller can request payment from the payment system conveniently. Furthermore, when the payment system and the payment method of the present invention are used in combination with a banking system of a financial institute, exchanges between fiat currencies and digital currencies can be done in response to operations from the users (e.g., donators, beneficiaries, or sellers) so that the payment system can serve the users more conveniently.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A payment system, comprising:
a digital currency recording device, being configured to store an identifier of a first beneficiary and a first donation beneficiary record related to a first donation from a first donator to the first beneficiary, wherein the first donation beneficiary record comprises a first beneficial digital currency account identifier, a first donation disbursement condition, and a first beneficiary digital currency balance; and
an auditing system, being electrically connected to the digital currency recording device and a sales terminal device and configured to receive the first beneficial digital currency account identifier, a product identifier, and a bill of a consumption fee from the sales terminal device, determine that the product identifier conforms to the first donation disbursement condition and that a subsidized fee related to the consumption fee is not greater than the first beneficial digital currency balance, and subtract the subsidized fee from the first beneficial digital currency balance according to the determination result that the product identifier conforms to the first donation disbursement condition and that the subsidized fee related to the consumption fee is not greater than the first beneficial digital currency balance.

2. The payment system of claim 1, wherein the digital currency recording device further stores a second donation beneficiary record related to a second donation from the first donator to the first beneficiary, and the second donation beneficiary record comprises a second beneficial digital currency account identifier, a second donation disbursement condition, and a second beneficial digital currency balance.

3. The payment system of claim 1, wherein the digital currency recording device further stores a second donation beneficiary record related to a donation from a second donator to the first beneficiary, and the second donation beneficiary record comprises a second beneficial digital currency account identifier, a second donation disbursement condition, and a second beneficial digital currency balance.

4. The payment system of claim 1, wherein the digital currency recording device further stores an identifier, a digital currency account identifier, and a digital currency balance of the first donator, and the payment system further comprises:
a finance processing device, being electrically connected to the digital currency recording device and configured to receive the identifier of the first donator, the identifier of the first beneficiary, the first beneficial digital currency account identifier, the first donation disbursement condition, and the first beneficial digital currency balance, record the first beneficial digital currency account identifier, the first donation disbursement condition, and the first beneficial digital currency balance into the first donation beneficiary record, and subtract the first beneficial digital currency balance from the digital currency balance of the first donator.

5. The payment system of claim 4, wherein the first beneficial digital currency balance corresponds to a beneficial fiat currency balance according to an exchange rate, the finance processing device further subtracts the beneficial fiat currency balance from a fiat currency balance of the first donator, and the finance processing device further adds the beneficial fiat currency balance to a fiat currency balance of an operation institute of the payment system.

6. The payment system of claim 4, wherein the first beneficial digital currency balance corresponds to a first digital currency type, the first beneficial digital currency balance corresponds to a second beneficial digital currency balance according to an exchange rate, the second beneficial digital currency balance corresponds to a second digital currency type, the finance processing device further subtracts the second beneficial digital currency balance from a digital currency balance of the second digital currency type of the first donator, and the finance processing device further adds the second beneficial digital currency balance to a digital currency balance of the second digital currency type of an operation institute of the payment system.

7. The payment system of claim 1, wherein the digital currency recording device further stores an identifier of a second beneficiary and a second donation beneficiary record related to a donation from the first donator to the second beneficiary, and the second donation beneficiary record comprises a second beneficiary digital currency account identifier, a second donation disbursement condition, and a second beneficial digital currency balance.

8. The payment system of claim 1, further comprising:
a finance processing device, being electrically connected to the digital currency recording device and configured to determine that a fiat currency balance of an operation institute of the payment system in a financial institute is greater than a withdrawal fiat currency amount, add the withdrawal fiat currency amount to a fiat currency balance of a withdrawer in the financial institute, subtract the withdrawal fiat currency amount from the fiat currency balance of the operation institute in the financial institute, and subtract a withdrawal digital currency amount from a digital currency balance of a digital currency account of the withdrawer,
wherein the withdrawal digital currency amount corresponds to the withdrawal fiat currency amount according to an exchange rate, and the withdrawer is one of the first donator and a seller.

9. The payment system of claim 1, further comprising:
a finance processing device, being electrically connected to the digital currency recording device and configured to determine that a first fiat currency balance of an operation institute of the payment system in a first financial institute is smaller than a withdrawal fiat currency amount, subtract a transfer amount and a commission fee from a second fiat currency balance of the operation institute in a second financial institute, add the transfer amount to the first fiat currency balance of the operation institute in the first financial institute, add the withdrawal fiat currency amount to a fiat currency balance of a withdrawer in the first financial institute, subtract the withdrawal fiat currency amount from the first fiat currency balance of the operation institute in the first financial institute, and subtract a withdrawal digital currency amount from a digital currency balance of a digital currency account of the withdrawer,
wherein the withdrawal digital currency amount corresponds to the withdrawal fiat currency amount according to an exchange rate, and the withdrawer is one of the first donator and a seller.

10. The payment system of claim 1, further comprising:
a finance processing device, being electrically connected to the digital currency recording device and configured to add the beneficial digital currency balance to a digital currency balance of the first donator, and zero the beneficial digital currency balance of the first donation beneficiary record.

11. The payment system of claim 1, further comprising:
a finance processing device, being electrically connected to the digital currency recording device and configured to subtract a payout-request digital currency amount from a digital currency total amount of an operation institute of the payment system, and add the payout-request digital currency amount to a digital currency balance of a digital currency account of a seller corresponding to the sales terminal device.

12. A payment method adapted for a serving system, the serving system storing an identifier of a first beneficiary and a first donation beneficiary record related to a first donation from a first donator to the first beneficiary, the first donation beneficiary record comprising a first beneficial digital currency account identifier, a first donation disbursement condition, and a first beneficiary digital currency balance, the payment method comprising:
receiving the first beneficial digital currency account identifier, a product identifier, and a bill of a consumption fee from a sales terminal device;
determining that the product identifier conforms to the first donation disbursement condition and that a subsidized fee related to the consumption fee is not greater than the first beneficial digital currency balance; and
subtracting the subsidized fee from the first beneficial digital currency balance according to the determination result that the product identifier conforms to the first donation disbursement condition and that the subsidized fee related to the consumption fee is not greater than the first beneficial digital currency balance.

13. The payment method of claim 12, wherein the serving system further stores a second donation beneficiary record related to a second donation from the first donator to the first beneficiary, and the second donation beneficiary record comprises a second beneficial digital currency account identifier, a second donation disbursement condition, and a second beneficial digital currency balance.

14. The payment method of claim 12, wherein the serving system further stores a second donation beneficiary record related to a donation from a second donator to the first beneficiary, and the second donation beneficiary record comprises a second beneficial digital currency account identifier, a second donation disbursement condition, and a second beneficial digital currency balance.

15. The payment method of claim 12, wherein the serving system further stores an identifier, a digital currency account identifier, and a digital currency balance of the first donator, and the payment method further comprises:
receiving the identifier of the first donator, the identifier of the first beneficiary, the first beneficial digital currency account identifier, the first donation disbursement condition, and the first beneficial digital currency balance;
recording the first beneficial digital currency account identifier, the first donation disbursement condition, and the first beneficial digital currency balance into the first donation beneficiary record; and
subtracting the first beneficial digital currency balance from the digital currency balance of the first donator.

16. The payment method of claim 15, wherein the first beneficial digital currency balance corresponds to a beneficial fiat currency balance according to an exchange rate, and the payment method further comprises:
subtracting the beneficial fiat currency balance from a fiat currency balance of the first donator; and
adding the beneficial fiat currency balance to a fiat currency balance of an operation institute of the payment system.

17. The payment method of claim 15, wherein the first beneficial digital currency balance corresponds to a first digital currency type, the first beneficial digital currency balance corresponds to a second beneficial digital currency balance according to an exchange rate, the second beneficial digital currency balance corresponds to a second digital currency type, the payment method further comprises:
subtracting the second beneficial digital currency balance from a digital currency balance of the second digital currency type of the first donator; and
adding the second beneficial digital currency balance to a digital currency balance of the second digital currency type of an operation institute of the payment system.

18. The payment method of claim 12, wherein the serving system further stores an identifier of a second beneficiary and a second donation beneficiary record related to a donation from the first donator to the second beneficiary, and the second donation beneficiary record comprises a second beneficiary digital currency account identifier, a second donation disbursement condition, and a second beneficial digital currency balance.

19. The payment method of claim 12, further comprising:
determining that a fiat currency balance of an operation institute of the payment system in a financial institute is greater than a withdrawal fiat currency amount;
adding the withdrawal fiat currency amount to a fiat currency balance of a withdrawer in the financial institute;
subtracting the withdrawal fiat currency amount from the fiat currency balance of the operation institute in the financial institute; and
subtracting a withdrawal digital currency amount from a digital currency balance of a digital currency account of the withdrawer,
wherein the withdrawal digital currency amount corresponds to the withdrawal fiat currency amount according to an exchange rate, and the withdrawer is one of the first donator and a seller.

20. The payment method of claim 12, further comprising:
determining that a first fiat currency balance of an operation institute of the payment system in a first financial institute is smaller than a withdrawal fiat currency amount;
subtracting a transfer amount and a commission fee from a second fiat currency balance of the operation institute in a second financial institute;
adding the transfer amount to the first fiat currency balance of the operation institute in the first financial institute;
adding the withdrawal fiat currency amount to a fiat currency balance of a withdrawer in the first financial institute;
subtracting the withdrawal fiat currency amount from the first fiat currency balance of the operation institute in the first financial institute; and
subtracting a withdrawal digital currency amount from a digital currency balance of a digital currency account of the withdrawer,
wherein the withdrawal digital currency amount corresponds to the withdrawal fiat currency amount according to an exchange rate, and the withdrawer is one of the first donator and a seller.

21. The payment method of claim 12, further comprising:
adding the beneficial digital currency balance to a digital currency balance of the first donator; and
zeroing the beneficial digital currency balance of the first donation beneficiary record.

22. The payment method of claim 11, further comprising:
subtracting a payout-request digital currency amount from a digital currency total amount of an operation institute of the payment system; and
adding the payout-request digital currency amount to a digital currency balance of a digital currency account of a seller corresponding to the sales terminal device.
